(19) United States
(12) Patent Application Publication
(10) Pub. No.: US 2016/0242997 A1
(43) Pub. Date: Aug. 25, 2016

(54) Acupressure Device

(71) Applicant: Barry Michael David Ho, Winnipeg (CA)

(72) Inventor: Barry Michael David Ho, Winnipeg (CA)

(21) Appl. No.: 15/147,067

(22) Filed: May 5, 2016

Related U.S. Application Data
(60) Provisional application No. 62/213,881, filed on Sep. 3, 2015.

(51) Int. Cl. A61H 39/04

(52) U.S. Cl. CPC A61H 39/04; A61H 2201/1638; A61H 2201/165

(57) ABSTRACT

An acupressure device applies pressure to the pericardium acupressure point on a wrist of a user for the relief of nausea. The device has a frame element including two opposing end portions with adhesive thereon for adhering to skin of the user. A protruding element is supported on the frame element to protrude from an inner surface of the frame element at a location which is between the two end portions of the frame element in a lateral direction of the frame element. The frame element is formed of a resilient material which is arranged to undergo bending stresses when flexed about a bending axis oriented transversely to the lateral direction whereby the protruding element is arranged to apply pressure to the pericardium acupressure point when the adhesive material at the two end portions is adhered to skin of the user at laterally opposing sides of the pericardium acupressure point.

This application claims the benefit under 35 U.S.C. 119(e) of U.S. provisional application Ser. No. 62/213,881, filed Sep. 3, 2015.

### FIELD OF THE INVENTION

The present invention relates to an acupressure device for applying pressure to the pericardium acupressure point on a wrist of a user, and more particularly the present invention relates to an acupressure device including a frame element supporting a protruding element thereon for alignment with the pericardium acupressure point and adhesive material for adhering the frame element to skin of the user at opposing sides of the pericardium acupressure point such that bending stresses in the frame element apply pressure to the protruding element against the pericardium acupressure point.

### BACKGROUND

A portion of the population experience nausea, which is inconvenient and also potentially very debilitating. A common treatment is by medication where the efficacy of treatment can vary and often includes medication where such treatment can have significant adverse side effects. Another common treatment is anti-nausea wrist devices which are non-medicinal. These devices are of various compositions all of which include a protruding device (half sphere). The most common devices are wrist bands that are worn around the wrist. One type is constructed of elasticised fabric that is stretched over the hand and applied onto the wrist, and another type is constructed of a material that is rigid (not elasticised) and is similar to common wristwatch bands that incorporates an adjustable buckle and strap mechanism, or hook and loop mechanisms, and applied onto the wrist. Another type is an adhesive bandage style that is applied to the wrist.

Anti-nausea wrist devices have been moderately known and used for many years, though require a continuing need for improvement. The wrist band type, when worn on the wrist, applies inward pressure on the wrist, which incorporates a protruding half-sphere shaped or similar device, that is located on the band and placed at the medial wrist at the Pericardium 6 (P6) pressure point. The band acts to apply pressure on the protruding half-sphere shaped or similar device, which then applies pressure to the Pericardium 6 (P6) pressure point. The adhesive bandage type also incorporate a protruding half-sphere shaped or similar device, and relies on the adhesion of the bandage on the surrounding wrist skin, to apply pressure on the sphere to then apply pressure on the Pericardium 6 (P6) pressure point. The pressure of the wrist band type and the bandage type devices acts to reduce nausea of the wearer. Users have reported significant reduction in nausea when wearing the band type devices, and scientific studies have shown similar reductions in nausea with the use of these devices. One common wrist band type is manufactured under the name of Sea-Band.

Current anti-nausea wrist band types have several disadvantages. These bands apply pressure around the entire circumference of the wrist, while pressure is only required at the medial Pericardium 6 (P6) area. This pressure must be sufficient enough to apply the required pressure on the protruding half sphere shaped or similar device, to subsequently allow it to apply sufficient pressure on the Pericardium 6 (P6) area. This band pressure exerted on the entire wrist circumference causes discomfort and can reduce blood circulation and nerve conduction to and from the hand. In addition, these band types can move away or drift from their intended wrist location with normal arm and hand movement, causing the device to fail in its application of pressure on the Pericardium 6 (P6) area, making it ineffective at reducing nausea. To reduce the negative effects of this movement, some manufacturers of the band types recommend the use of two devices, one on each wrist, in the event one of them moves from its intended location on the wrist, yet the application of only one device has been shown to reduce nausea. Also, the elasticised wrist band types are constructed to be significantly tight on the circumference of the wrist to minimize potential unwanted movement on the wrist, away from the intended location, and to compensate for the elasticized fabrics pliable area at the protruding half sphere shaped or similar device mounting location which results in the unwanted reduction of pressure on the device itself. The functional necessity of the tightness causes the unwanted side effects of reduced hand circulation and reduced hand nerve conduction.

Current anti-nausea adhesive bandage types also have a disadvantage. These adhesive bandages are not made of rigid fabric or material and easily flex away from the wrist surface area at the half sphere shaped or similar device. This reduces the pressure on the protrusion device, and can cause it to rely solely on the strength of the adhesive immediately adjacent the protrusion.

### SUMMARY OF THE INVENTION

According to one aspect of the invention there is provided an acupressure device for applying pressure to the pericardium acupressure point on a wrist of a user, the device comprising:

a frame element including two opposing end portions, an intermediate portion which extends in a lateral direction between the end portions, an inner surface, and an outer surface opposite to the inner surface;

adhesive material on the inner surface of the frame element at each of the end portions of the frame element; and

a protruding element supported on the frame element to protrude from the inner surface of the intermediate portion at a location which is laterally between the two end portions of the frame element;

the frame element formed of a resilient material which is arranged to undergo bending stresses when flexed about a bending axis oriented transversely to the lateral direction whereby the protruding element is arranged to apply pressure to the pericardium acupressure point of the user when the adhesive material at the two end portions is adhered to skin of the user at laterally opposing sides of the pericardium acupressure point.

According to a second aspect of the present invention there is provided a method of applying pressure to the pericardium acupressure point on a wrist of a user, the method comprising:

providing an acupressure device comprising i) a frame element formed of resilient material including two opposing end portions, an intermediate portion which extends in a lateral direction between the end portions, an inner surface, and an outer surface opposite to the inner surface, and ii) a protruding element supported on the frame element to protrude from the inner surface of the intermediate portion at a location which is laterally between the two end portions of the frame element; and

adhering the inner surface of the frame element at each of the end portions of the frame element to skin of the user at laterally opposing sides of the pericardium acupressure point such that i) the frame element is flexed about a bending axis oriented transversely to the lateral direction so as to undergo bending stresses and ii) the protruding element applies pressure to the pericardium acupressure point.

According to the preferred embodiment, the present invention is a wrist compressor for compressing the medial wrist at the Pericardium 6 (P6) area. The wrist compressor comprises a frame element having a first end region adapted to engage the outer skin wall of the wrist radial to the Pericardium 6 (P6) area. A second end region of the frame element is configured to engage the outer skin wall of the wrist on the opposing radial to the Pericardium 6 (P6) area. The first and second end regions of the frame element are coupled to one another by an intermediate segment. The intermediate segment is configured to traverse a portion of the wrist located at the Pericardium 6 (P6). The frame element also includes a protruding segment positioned at the center point of the frame element which, when in place, acts to apply pressure to the medial wrist at the Pericardium 6 (P6) area reducing nausea. The frame element includes a flexible strip of material that defines the first and second end regions and the intermediate segment of the wrist compressor. The resiliency of the frame element compresses the half sphere shaped protruding segment on the Pericardium P6 area on the wrist. The frame element further includes an adhesive substance located on the flexible strip of material. The adhesive substance acts to reasonably secure the frame element to the outer wall tissue of the Pericardium P6 area of the wrist. One or more release liners cover the adhesive substance on the first and second end regions until the device is ready to be applied to the skin of the user. The release liners are readily removable from the strip of material to expose the adhesive substance and permit the frame element to be secured to the Pericardium P6 area of the wrist. This wrist compressor is of efficient design and effectively exerts pressure on the Pericardium P6 area of the wrist reducing nausea without the side effects of other wrist compressor devices. Moreover, this wrist compressor can be worn for longer durations due to the reduced side effects, and is less visible to others and more visually appealing as it is worn on the medial side of the wrist compared to other wrist compressors that cover the full circumference of the wrist and are more visible to others.

Preferably the resilient material forming the frame element is arranged to apply sufficient pressure to the pericardium acupressure point when flexing the frame element about the wrist of the user to provide relief from nausea.

A cross-sectional area of the adhesive material spanning the inner surface of the frame element which adheres the inner surface to the skin of the user is typically greater than 2 square inches, and is preferably 3 square inches or more. In a preferred embodiment, the area of the inner surface of the frame element is near 4 square inches and the entire inner surface surrounding all sides of the protruding element includes adhesive material thereon.

In one preferred embodiment, a length of the frame element in the lateral direction corresponding to a length across a width of the wrist, is greater than a length of the frame element in a transverse direction perpendicular to the lateral direction corresponding to a length of the frame element in a transverse direction along a length of the wrist of the user; however, the length of the frame element in the lateral direction preferable remains very close to the length in the perpendicular transverse direction. For example, the length across the wrist may be 2.25 inches while the length along the wrist may be nearer to 2 inches.

Preferably the frame element further comprises two side portions along opposing sides of the intermediate portion to extend outwardly therefrom in a transverse direction which is perpendicular to the lateral direction, and the adhesive material is further provided on the inner surface of the frame element at each of the side portions of the frame element. This allows for adhering the inner surface of the frame element at the two opposing side portions located along opposing sides of the intermediate portion in the transverse direction.

In this instance, the frame element is preferably further arranged to undergo bending stresses when flexed about a second axis oriented perpendicularly to the bending axis whereby the protruding element is arranged to apply further pressure to the pericardium acupressure point of the user when the adhesive material is adhered to skin of the user at the transversely opposing sides of the pericardium acupressure point.

Preferably the frame element is formed to resist bending about the second axis to a greater degree than bending about said bending axis when the frame element is curved about the bending axis.

This may be accomplished by forming the frame element from a sheet of material which is arranged to undergo bending stresses to resist bending about two axes which are perpendicular to one another. More particularly, the method may include curving the frame element about the bending axis such that the frame element resists bending about the second axis perpendicular to the first axis to a greater degree than the frame element resists bending about the bending axis.

Various embodiments of the invention will now be described in conjunction with the accompanying drawings in which:

### BRIEF DESCRIPTION OF THE DRAWINGS

FIG. 1 is a perspective view of the acupressure device according to a first embodiment, shown applied to the pericardium acupressure point on the wrist of a user;

FIG. 2 is a partly sectional perspective view of the wrist of the user in which the acupressure device according to the first embodiment of FIG. 1 is shown in broken line;

FIG. 3 is a sectional view along the line 3-3 of FIG. 1;

FIG. 4 is a sectional view along the line 4-4 of FIG. 1; and

FIG. 5 is a perspective view of the acupressure device according to a second embodiment, shown applied to the pericardium acupressure point on the wrist of a user.

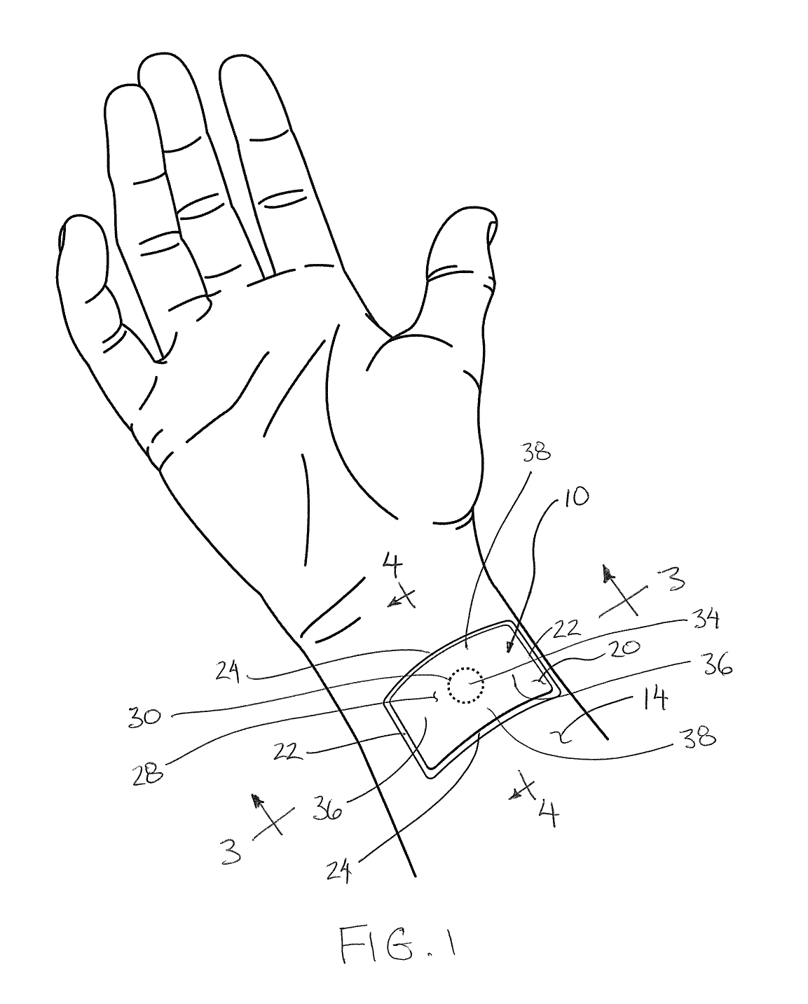

In the drawings like characters of reference indicate corresponding parts in the different figures.

### DETAILED DESCRIPTION

Referring to the accompanying figures there is illustrated an acupressure device generally indicated by reference numeral 10. The device 10 is particularly suited for applying pressure to the pericardium acupressure point of a user for the relief of nausea.

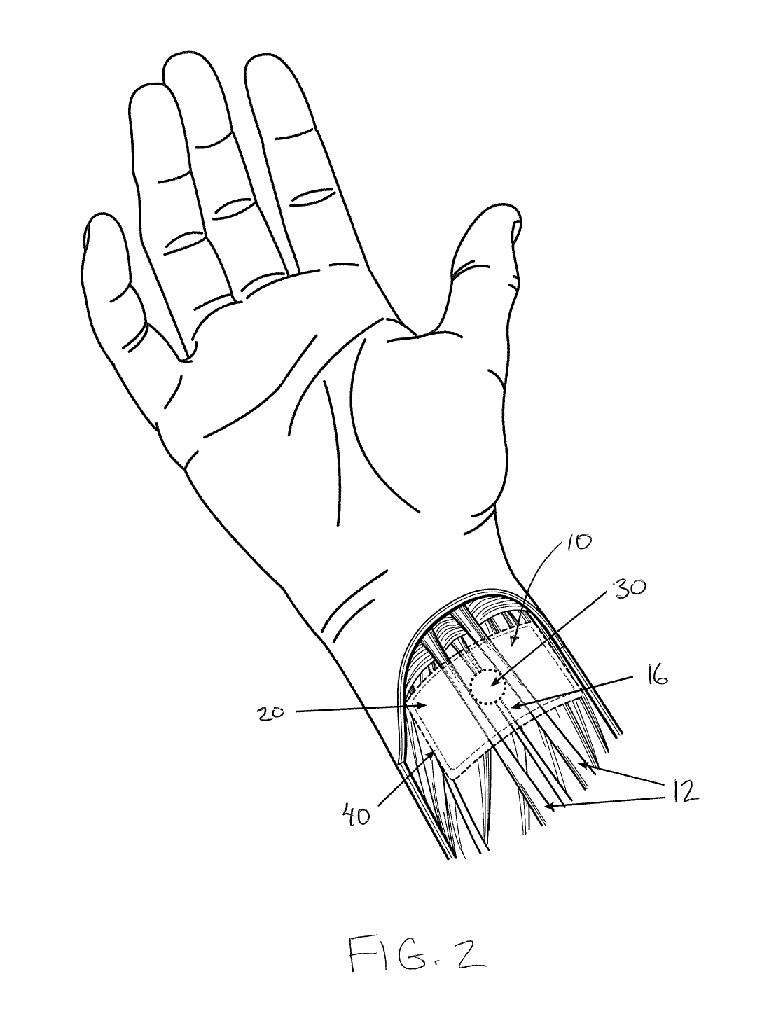

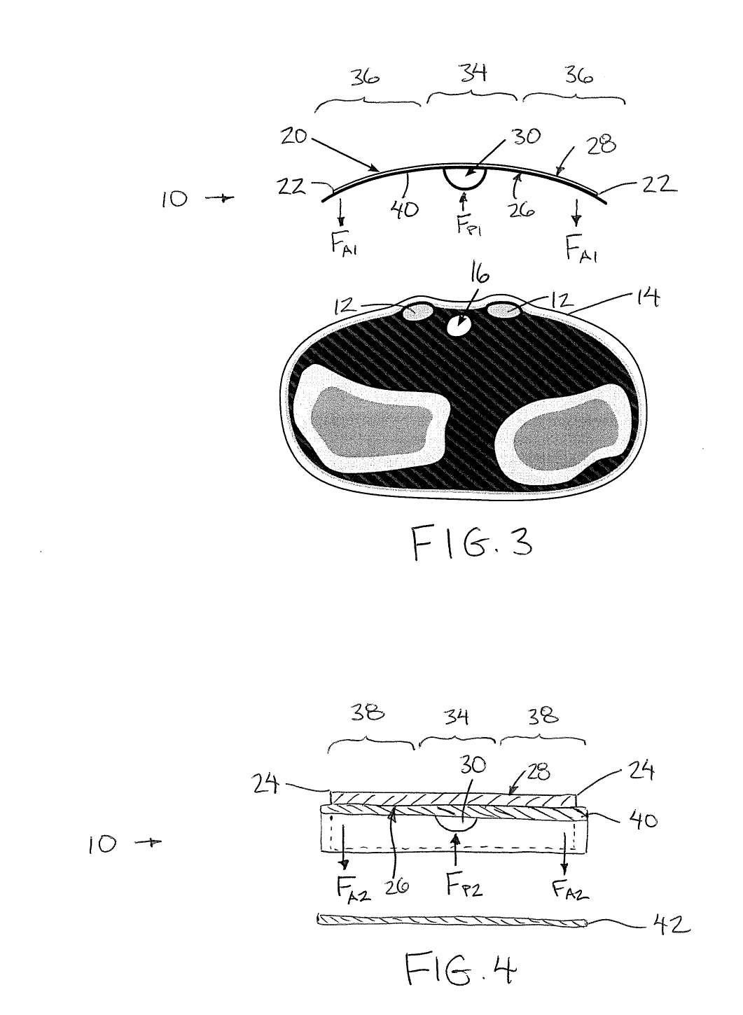

As shown in FIGS. 2 and 3 the device 10 is typically mounted along the inner side of the wrist of a user where there is located two tendons 12 near the surface of the skin 14 of the user in which the tendons are parallel and spaced apart to extend in the longitudinal direction of the forearm. The median nerve 16 extends longitudinally with the tendons at a location laterally between the tendons. The device 10 applies pressure to the median nerve 16, between the tendons 12, at the wrist area of the forearm so as to be closer to the hand of the user than the elbow.

The device 10 includes a frame element 20 in the form of a generally planar sheet which is rectangular in shape and which has sufficient rigidity to be self-supporting in a relaxed state while being sufficiently resilient to allow resilient bending about at least one axis as described in further detail below.

The frame element 20 has an overall width in a lateral direction between two opposing ends 22 of the sheet and has an overall length in a longitudinal direction which is perpendicular to the lateral direction between two opposing side edges 24 which are laterally oriented between the two ends 22.

In one preferred embodiment, the frame element spans a lateral width of 2¼ inches while having a length between the opposed side edges 24 which is near to the width but is slightly less than the width so as to have a dimension of approximately 2 inches or 2⅛ inches.

The frame element 20 further includes an inner surface 26 and an opposing outer surface 28 which are broad surfaces that nearly fully span the width and the length. The inner surface 26 is intended for mounting directly against the skin of the user, whereas the opposing outer surface 28 faces outwardly away from the user.

The resilient material forming the frame element 20 enables the planar sheet to be bent about a bending axis oriented in the longitudinal direction, perpendicular to the lateral direction, such that the sheet conforms to the curvature of the wrist of the user in a circumferential direction about the arm of the user. The sheet forming the frame element is curved to form a shape which is part of a surface of a cylinder in a mounted position on the arm of the user.

Bending or flexing the frame element into the curved shape about the wrist so as to be bent about the prescribed bending axis induces bending stresses in the frame element which urge the element to return to a planar and/or unflexed state. Once bent in a curve about the bending axis to conform to the curvature in the circumferential direction about the wrist of the user, the resilient material forming the frame element provides greater resistance to flexing or bending about a lateral axis oriented perpendicularly to the bending axis such that the sheet forming the frame element generally maintains a partial cylindrical shape.

The device 10 further includes a protruding element 30 which is mounted on the inner surface to protrude therefrom at a location which is generally centred in the lateral direction between the opposing ends 22 while also being generally centred in the longitudinal direction between the opposing side edges 24.

The protruding element 30 is accordingly supported on a centrally located intermediate portion 34 of the frame element 20. The frame element thus includes two end portions 36 extending in laterally opposing directions away from the intermediate portion 34 towards respective ones of the two opposing ends 22. The frame element thus also includes two opposing side portions 38 extending in the lateral direction between the opposing ends 22 at longitudinally opposed sides of the intermediate portion 34. The side portions 38 extend in opposing longitudinal directions from the intermediate portion 34 towards respective ones of the opposing side edges 24.

The protruding element 30 has a semi-spherical shape in which a flat inner side is mounted directly against the inner surface of the frame element and a convex outer side protrudes from the plane of the frame element 20. The diameter of the protruding element 30 is typically less than half an inch such that the protrusion readily fits between the two tendons 12 of a user to apply adequate pressure to the median nerve 16 therebetween.

The device 10 further includes an adhesive layer 40 which fully spans the inner surface of the frame element so as to fully surround all sides of the protruding element. Accordingly, the adhesive layer fully spans both opposing end portions 36 of the frame element and both opposing side portions 38 of the frame element. When using a device according to the preferred embodiment noted above, having dimensions of 2¼ inches by 2 inches, results in the adhesive area spanning an area which is at least 2 square inches, and is preferably at least 3 square inches for contacting a corresponding surface area of the skin of the user to which the adhesive layer is bonded in use.

The adhesive layer 40 may comprise adhesive applied directly to the inner surface of the frame element 20, or alternatively, the adhesive layer 40 may comprise a carrier layer of fabric material for example which is bonded to the inner surface of the frame element and which supports adhesive material on the inner surface thereof for contacting the skin of the user.

A release layer 42 in the form of a sheet of material which is adapted to be readily released from the adhesive layer 40 is arranged to fully span the inner side of the adhesive layer during packaging, before use of the device 10. Removal of the release layer exposes the adhesive layer to permit the adhesive layer to be bonded to the skin of the user about the pericardium acupressure point when the protruding element 30 is aligned with the pericardium acupressure point. The adhesive layer 40 comprises a suitable adhesive to form a secure adhesive bond to the outer skin of the user while remaining releasable from the user when the use of the device is no longer desired.

The device 10 is mounted onto the outer skin of the user by orienting the lateral direction of the frame element to extend across the wrist and follow the curvature of the wrist in the circumferential direction about the forearm of the user. The adhesive material on the two end portions 36 secures the outer end portions to the skin of the user to maintain the shape of the frame element 20 to be curved about the prescribed bending axis oriented perpendicularly to the lateral direction. This orientation of the frame element 20 causes the longitudinal direction between the opposing side edges to be aligned with the longitudinal direction of the forearm of the user.

Pressing the protruding element 30 into the body of the user at the location of the pericardium acupressure point together with adhesive bonding of the frame element about the full perimeter of the protruding element to the skin of the user induces bending stresses in the frame element in two directions corresponding to bending or flexing about two axes which are perpendicular to one another.

As shown in FIG. 3, the frame element provides the function of a first beam extending in the lateral direction in which opposing ends of the first beam are defined by the outer end portions 36 which are pulled inwardly against the skin of the user by the force of the adhesive as designated by reference character F_{A1}. The force of the adhesive at laterally opposed end portions 36 is balanced with the force of the protruding element against the skin which generates a corresponding force F_{P1} which urges the centre of the beam outward to cause the corresponding curvature in the frame element about the bending axis.

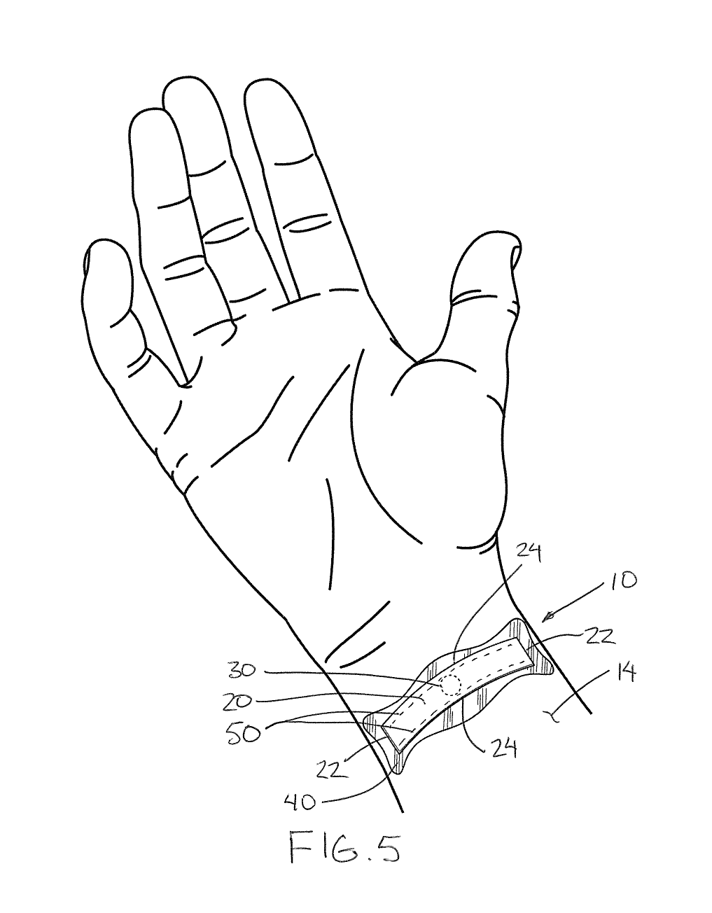

As shown in FIG. 4, the frame element 20 also provides the function of a second beam extending in the longitudinal direction in which opposing ends of the second beam are defined by the opposing side portions 38 which are pulled inwardly against the skin of the user by the force of the adhesive as designated by reference character F_{A2}. The force of the adhesive at longitudinally opposed side portions 38 is balanced with the force of the protruding element against the skin which generates a corresponding force F_{P2} which attempts to urge the centre of the beam outward.

The resulting force of the protruding element pressed against the outer skin of the user so as to apply pressure to the median nerve thus corresponds to the summation of F_{P1} and F_{P2} resulting from the effective laterally oriented first beam and the effective longitudinally oriented second beam defined by the sheet of material forming the frame element 20.

In further embodiments as shown in FIG. 5, the adhesive layer 40 may be provided on a flexible carrier layer, for example a fabric layer which has greater dimensions in the lateral and longitudinal directions then the bendable frame element 20. Furthermore, as shown in FIG. 5, the frame element may be elongate in the lateral direction so as to function primarily as a single beam oriented in the lateral direction whereby the bending stresses resulting from flexing about the single bending axis when conforming to the curvature of the wrist provides sufficient force against the user at the pericardium acupressure point to provide relief from nausea.

In yet further embodiments, the frame element may comprise a composite of a base layer together with additional resilient beam elements 50 as shown in broken line in FIG. 5 to extend in the lateral direction between the opposing ends 22. The beam elements may be stiffer than the base layer to induce greater bending stresses in the beam elements and thereby generate greater force of the protruding element against the pericardium acupressure point even if the frame element functions primarily as a single beam oriented in the lateral direction. Additional beam elements can also be incorporated in the longitudinal direction as desired in yet further embodiments.

Since various modifications can be made in my invention as herein above described, and many apparently widely different embodiments of same made, it is intended that all matter contained in the accompanying specification shall be interpreted as illustrative only and not in a limiting sense.

1. An acupressure device for applying pressure to the pericardium acupressure point on a wrist of a user, the device comprising:
a frame element including two opposing end portions, an intermediate portion which extends in a lateral direction between the end portions, an inner surface, and an outer surface opposite to the inner surface;
adhesive material on the inner surface of the frame element at each of the end portions of the frame element; and
a protruding element supported on the frame element to protrude from the inner surface of the intermediate portion at a location which is laterally between the two end portions of the frame element;
the frame element formed of a resilient material which is arranged to undergo bending stresses when flexed about a bending axis oriented transversely to the lateral direction whereby the protruding element is arranged to apply pressure to the pericardium acupressure point of the user when the adhesive material at the two end portions is adhered to skin of the user at laterally opposing sides of the pericardium acupressure point.

2. The device according to claim 1 wherein the resilient material forming the frame element is arranged to apply sufficient pressure when flexing the frame element about the wrist of the user to provide relief from nausea.

3. The device according to claim 1 wherein a cross sectional area of the adhesive material spanning the inner surface of the frame element is greater than 2 square inches.

4. The device according to claim 1 wherein a length of the frame element in the lateral direction is greater than a length of the frame element in a transverse direction perpendicular to the lateral direction.

5. The device according to claim 1 wherein a length of the frame element in the lateral direction is near a length of the frame element in a transverse direction perpendicular to the lateral direction.

6. The device according to claim 1 wherein the frame element further comprises two side portions along opposing sides of the intermediate portion to extend outwardly therefrom in a transverse direction which is perpendicular to the lateral direction, and wherein the adhesive material is further provided on the inner surface of the frame element at each of the side portions of the frame element.

7. The device according to claim 1 wherein the frame element is further arranged to undergo bending stresses when flexed about a second axis oriented perpendicularly to the bending axis whereby the protruding element is arranged to apply further pressure to the pericardium acupressure point of the user when the adhesive material is adhered to skin of the user at transversely opposing sides of the pericardium acupressure point.

8. The device according to claim 7 wherein the frame element is formed to resist bending about the second axis to a greater degree than bending about said bending axis when the frame element is curved about the bending axis.

9. The device according to claim 1 wherein the frame element is formed of a sheet of material which is arranged to undergo bending stresses to resist bending about two axes which are perpendicular to one another.

10. The device according to claim 1 for the relief of nausea.

11. A method of applying pressure to the pericardium acupressure point on a wrist of a user, the method comprising:
providing an acupressure device comprising i) a frame element formed of resilient material including two opposing end portions, an intermediate portion which extends in a lateral direction between the end portions, an inner surface, and an outer surface opposite to the inner surface, and ii) a protruding element supported on the frame element to protrude from the inner surface of the intermediate portion at a location which is laterally between the two end portions of the frame element; and
adhering the inner surface of the frame element at each of the end portions of the frame element to skin of the user at laterally opposing sides of the pericardium acupressure point such that i) the frame element is flexed about a bending axis oriented transversely to the lateral direction so as to undergo bending stresses and ii) the protruding element applies pressure to the pericardium acupressure point.

12. The method according to claim 11 including flexing the frame element so as to apply sufficient pressure to the pericardium acupressure point to provide relief from nausea.

13. The method according to claim 11 including adhering a cross sectional area of the inner surface of the frame element to skin of the user which is greater than 2 square inches.

14. The method according to claim 11 including orienting the frame element to be longer across a width of the wrist of the user than along a length of the wrist of the user.

15. The method according to claim 11 including supporting the frame element on the wrist of the user such that a length of the frame element across a width of the wrist of the user is near a length of the frame element in a transverse direction along a length of the wrist of the user.

16. The method according to claim 11 adhering the inner surface of the frame element at two opposing side portions located along opposing sides of the intermediate portion in a transverse direction which is perpendicular to the lateral direction.

17. The method according to claim 11 wherein the frame element is formed of a sheet of material which is arranged to undergo bending stresses to resist bending about two axes which are perpendicular to one another.

18. The method according to claim 11 including curving the frame element about the bending axis such that the frame element resists bending about a second axis perpendicular to the first axis to a greater degree than the frame element resists bending about the bending axis.
